(19) United States
(12) Patent Application Publication
(10) Pub. No.: US 2013/0309374 A1
(43) Pub. Date: Nov. 21, 2013

(54) Method of Heating Food

(71) Applicant: CHING-CHUAN LIN, Zhongpu Township (TW)

(72) Inventor: CHING-CHUAN LIN, Zhongpu Township (TW)

(21) Appl. No.: 13/472,449

(22) Filed: May 15, 2012

(51) Int. Cl. A23L 1/01

(52) U.S. Cl. 426/232

(57) ABSTRACT

A method of heating food is provided, which employs a cooker provided with a control program and a reader to identify a food package attached with a coded object which embodies the parameters associated with the food package, the parameters including temperature and time, whereby the contents of the parameters of the coded object can be read by the reader and compared by the control program so that the control program can issue commands to conduct a heating procedure according to the contents of the parameters of the coded object. Thus, the food package can be heated or cooked more easily, conveniently, safely, and economically, and the disadvantages resulted from incorrectly manual operations can be avoided.

### TECHNICAL FIELD OF THE INVENTION

The present invention relates to a method of heating food, and more particularly to a method, wherein a cooker is provided with a control program and a reader to identify a food package attached with a coded object which embodies the temperature and the heating time associated with the food package, whereby the food package can be heated or cooked more easily, conveniently, safely, and economically, and the disadvantages resulted from incorrectly manual operations can be avoided.

### DESCRIPTION OF THE PRIOR ART

When a customer purchases a food package required to be heated, the food package is usually brought to a microwave oven by a clerk or the customer himself, and a heating for the food package is manually set according to the category of the food. Due to each food having its specific heating temperature and time requirement, such manual heating operation generally has the following disadvantages:

1. It is difficult for a customer to decide an appropriate heating time, which results in an excessive or insufficient heating for a food package.

2. When a heating for a food package is excessive, the food can be scorched in addition to a waste of electrical energy, resulting in the customer's complaints or loss of business reputation.

3. It is inconvenient for visually impaired persons, illiterate persons, children, and the aged to operate a conventional microwave oven.

Besides, the taste of the food can be affected due to an inappropriate heating of the microwave oven. When the clerk is busy, the customer may wait for the clerk to heat the food.

In view of the foregoing, there is a need to provide a method of heating food, whereby the information of a food can be read by a cooker, and the food can be heated properly according to the information of the food. With this method, the food can be heated more easily, conveniently, safely, and economically.

### SUMMARY OF THE INVENTION

The primary object of the present invention is to provide a method of heating food, whereby the food package can be heated or cooked more easily, conveniently, safely, and economically, so that the disadvantages resulted from incorrectly manual operations can be avoided, and the labor cost and energy consumption can be reduced.

According to one aspect of the above method, a cooker is provided with a control program and a reader to identify a food package attached with a coded object which embodies the parameters associated with the food package, the parameters including temperature and time, whereby the contents of the parameters of the coded object can be read by the reader and compared by the control program so that the control program can issue commands to conduct a heating procedure according to the contents of the parameters of the coded object. Thus, the food package can be heated or cooked more easily, conveniently, safely, and economically, the disadvantages resulted from incorrectly manual operations can be avoided, and tangible loss (including food and energy) and intangible loss (including time and business reputation) can be reduced.

According to another aspect of the above method, the coded object is in the form of a barcode, which can be a QR Code.

According to a further aspect of the above method, the reader is installed in the cooker or connected to the cooker in a way of external installation.

Other objects, advantages, and novel features of the present invention will become more apparent from the following detailed description when taken in conjunction with the accompanying drawings.

### BRIEF DESCRIPTION OF THE DRAWINGS

FIGS. 1 and 2 respectively show a 3-dimensional view of one preferred embodiment of the present invention.

FIG. 3 shows a flowchart of the present invention.

FIG. 4 shows a working view of the present invention.

FIG. 5 shows a 3-dimensional view of another embodiment of the present invention.

### DETAILED DESCRIPTION OF THE PREFERRED EMBODIMENTS

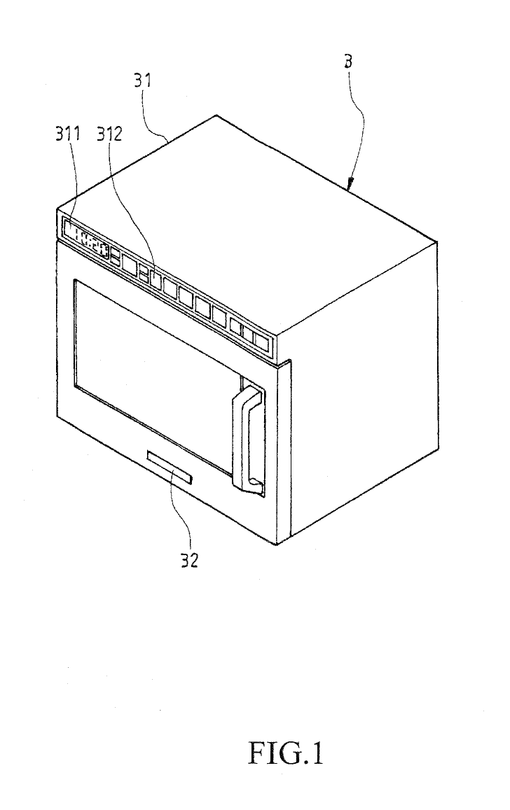

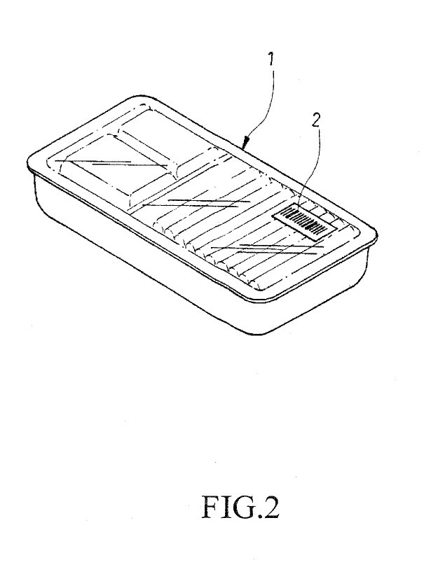

FIGS. 1 and 2 show a preferred embodiment of the present invention, wherein a coded object 2 is provided for a food package 1, which is intended to be heated via microwave. The coded object 2 can be printed or attached onto the food package 1. The coded object 2 embodies the parameters associated with the heating of the food package 1, the parameters including temperature, time and so on. The optimal values for those parameters are obtained from the test results by the manufacturer of the food package. Furthermore, the embodiment includes a cooker 3, which is provided with a reader 32 for reading the coded object 2 and provided with a control program for decoding the information read from the coded object 2, wherein the cooker 3 can be microwave oven, which may include a screen 311 and a keyboard 312. Preferably, the coded object 2 is in the form of a barcode, which can be a UPC (Universal Product Code) or a QR Code (Quick Response Code) or the like, while the reader 32 can be a barcode scanner, which can be installed in the cooker 3 and has a reading terminal exposed outside of the cooker 3.

With the present invention, the contents of the parameters embodied in the coded object 2 associated with the heating of the food package 1 can be read by the reader 32 and compared by the control program, which then can issue commands to operate the cooker 3 according to the contents of the parameters, including temperature and time, embodied in the coded object 2, thereby facilitating the heating or cooking of the food package 1 and avoiding an error due to inappropriately manual settings as seen in the conventional cookers. Therefore, the food package 1 can be heated to a desired condition more easily, safely, rapidly, and correctly. The present invention can be used in any types of applications, no matter for use in supermarkets, families or factories. When a customer purchases a food package 1, which is required to be heated, the food package 1 can be brought in front of the cooker 3 of the present invention by a clerk or the customer himself to conduct a heating for the food package 1. After the food package 1 is identified by the reader 32 provided for the cooker 3, and the contents of the parameters associated with the food package 1 is compared by the control program on the cooker 3, the control program can issue commands to operate the cooker 3 according to the contents of parameters, including temperature and time, embodied in the coded object 2, and allows the heating data to be displayed on the screen 311, so that the heating of the food package 1 can be operated with zero error and achieve an optimal result. Thus, the food package 1 can be heated or cooked more easily, safely, conveniently, and economically. Furthermore, during the operation, the heating can be manually terminated via the keyboard 312. Alternatively, the user is allowed to manually conduct a heating via the keyboard 312 instead of the above auto operation of the cooker 3.

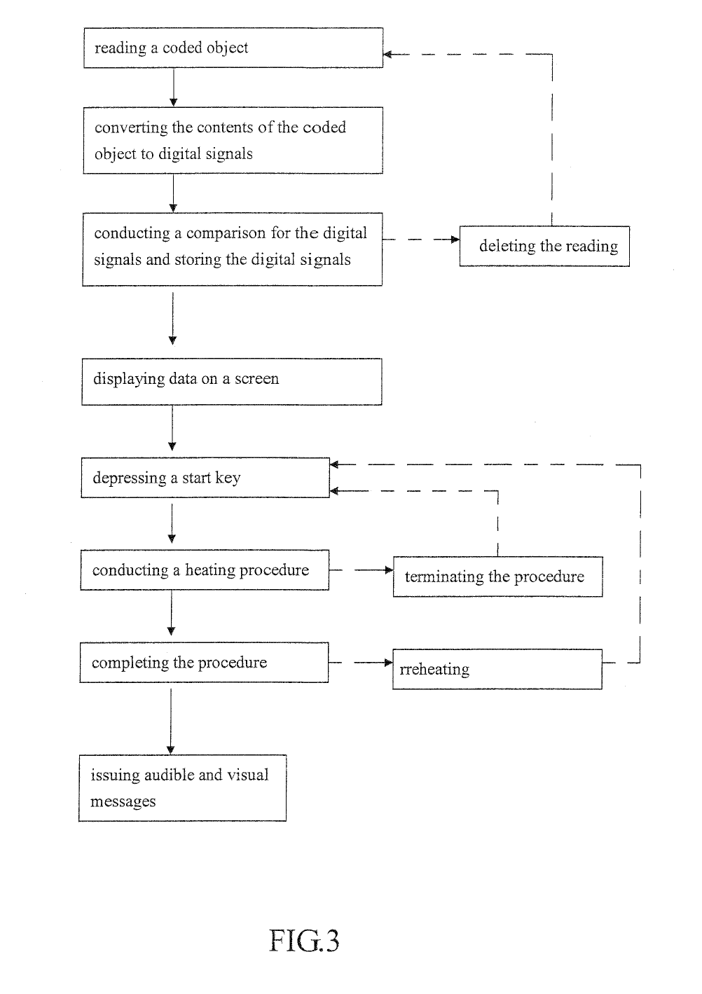

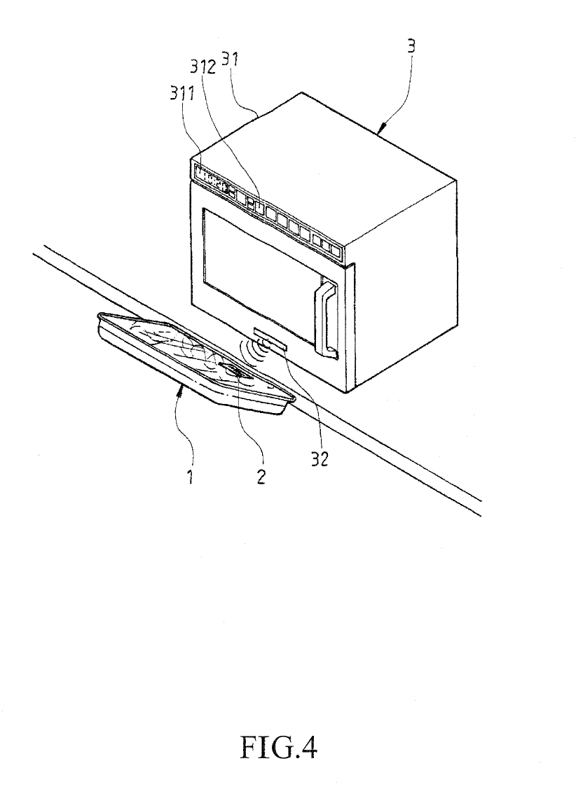

FIGS. 3 and 4 respectively show a flowchart and a working view of the present invention. As shown, the invention includes a method of heating food, which comprises the following steps:

1. providing a coded object 2 for a food package 1 that is required to be heated, wherein the coded object 2 is embodied with parameters associated with the food package 1, the parameters including temperature and time;

2. bringing the food package 1 in front of a cooker 3 to allow a reader 32 therein to conduct a reading for the coded object 2;

3. enabling the reader 32 to convert the contents of the parameters embodied in the coded object 2 to digital signals;

4. enabling the digital signals to be temporarily stored and compared by a control program provided on the cooker 3 to have the data, including the temperature and the heating time of the food package, displayed on a screen 311 of the cooker 3;

5. placing the food package 1 into the cooker 3 after the data displayed on the screen is confirmed, and then enabling the cooker 3 to conduct a heating procedure by depressing a start key, or returning to the step 2 by depressing a cancel key; alternatively, finishing a first stage of the heating procedure by depressing a pause key, and starting a second stage of the heating procedure by depressing the start key again, if necessary;

6. terminating the heating procedure by depressing an end key, if necessary;

7. issuing audible and visual messages after the cooker 3 completes the heating procedure; and

8. restarting the last heating procedure conducted by the cooker 3 by depressing the start key (i.e. reheating), if necessary.

9. Regarding the above heating, the coded object can be configured with one or more heating stages, each stage allowing to have a different temperature and a different heating time, for example, the coded object can be configured with one heating stage (heating); the coded object can be configured with two heating stages (pre-heating, heating); the coded object can be configured with three heating stages (defrosting, heating, re-heating); and so on.

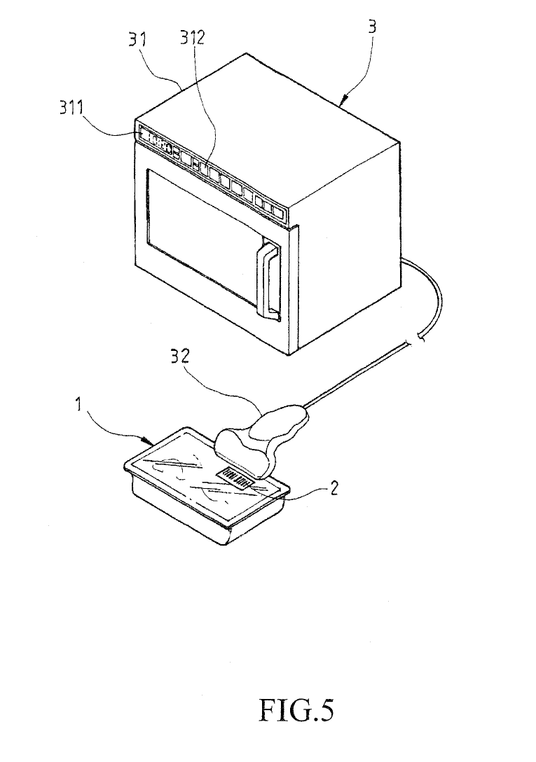

FIG. 5 shows another embodiment of the present invention, wherein a coded object 2 is provided for a food package 1, which is intended to be heated via microwave. The coded object 2 can be printed or attached onto the food package. The coded object 2 embodies the parameters associated with the heating of the food package 1, the parameters including temperature, time and so on. This embodiment includes a cooker 3, which is provided with a reader 32 for reading the coded object 2 and provided with a control program for decoding the reading information read from the coded object 2, wherein the cooker 3 can be microwave oven 31 having a screen 311 and a keyboard 312. Preferably, the coded object 2 is in the form of a barcode, which can be a UPC (Universal Product Code) or a QR Code (Quick Response Code) or the like, while the reader 32 can be a barcode scanner, which is connected to the cooker 3 in a way of external installation and is thus located outside of the cooker 3, and can be held in a hand of a user for conducting the reading.

With this embodiment, the contents of the parameters embodied in the coded object 2 can be read by the reader 32 held in the user's hand, and the control program provided on the cooker 3 can issue commands to allow the cooker 3 to conduct a heating procedure according to the contents of the parameters, including temperature and time, read from the coded object 2. Therefore, the heating or cooking of the food package can be proceeded more easily, conveniently, safely, and economically, so that the present invention can be easily operated by visually impaired persons and children. Also, this invention can avoid the disadvantage of incorrectly manual operations as seen in the conventional cookers. Moreover, the labor cost of heating food can be reduced; unnecessary loss and energy waste can be avoided.

The above embodiments are used only for illustrating the present invention and not for limiting the scope of the present invention. All trivial modifications or changes for the present invention, especially for the parameters of time, temperature and so on, are deemed within the essence of the present invention, and do not deviate from the spirit of the present invention.

In light of the foregoing, the present invention employs a cooker provided with a control program and a reader to identify a food package that is attached with a coded object, whereby the information of the coded object can be read by the reader and compared by the control program, and the control program can issue commands to conduct a heating procedure according to the read information, so that the food package can be heated or cooked more easily, conveniently, safely, and economically, and the disadvantages resulted from incorrectly manual operations as seen in conventional cookers can be avoided entirely. Accordingly, the present invention is a useful design, which can save energy and reduce carbon emission.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A method of heating food, which comprise the steps of:
providing a coded object for a food package that is required to be heated, wherein said coded object is embodied with parameters associated with said food package, the parameters including temperature and time;
providing a reader for a cooker;
bringing said food package required to be heated in front of said cooker to allow said reader to conduct a reading for said coded object;
enabling said reader to convert the contents of the parameters embodied in said coded object to digital signals to be temporarily stored and coded by a control program provided on said cooker for comparison;
placing said food package into said cooker and enabling said cooker to conduct a heating procedure; and
issuing audible and visual messages after said cooker completes the heating procedure.

2. A method of heating food as claimed in claim 1, wherein the contents of the parameters read from said coded object can be deleted if said food package is not intended to be heated, after said reader completes the reading.

3. A method of heating food as claimed in claim 1, wherein the heating procedure conducted by said cooker can be manually terminated.

4. A method of heating food as claimed in claim 1, wherein the heating procedure conducted by said cooker can be temporarily stopped so that a first stage of the heating procedure can be finished, and a second stage of the heating procedure can be started thereafter if necessary.

5. A method of heating food as claimed in claim 1, wherein said cooker includes a screen so that the data associated with temperature and time during the heating procedure can be displayed on the screen.

6. A method of heating food as claimed in claim 1, wherein said coded object is in the form of a barcode.

7. A method of heating food as claimed in claim 1, wherein said coded object can be a QR Code.

8. A method of heating food as claimed in claim 1, wherein said reader provided for said cooker is a barcode scanner.

9. A method of heating food as claimed in claim 8, wherein said barcode scanner is installed in said cooker and has a reading terminal exposed outside of said cooker for conducting the reading for said coded object.

10. A method of heating food as claimed in claim 8, wherein said barcode scanner is connected to said cooker in a way of external installation and can be held in a hand of a user to conduct the reading for said coded object.
